(19) United States
(12) Patent Application Publication
(10) Pub. No.: US 2023/0108953 A1
(43) Pub. Date: Apr. 6, 2023

(54) AUTONOMOUS VEHICLE INFRASTRUCTURE SERVICE FOR POWER LOSS EVENTS

(71) Applicant: AT&T Intellectual Property I, L.P., Atlanta, GA (US)

(72) Inventors: Barrett Kreiner, Woodstock, GA (US); James Pratt, Round Rock, TX (US); Adrianne Binh Luu, Atlanta, GA (US); Robert T. Moton, JR., Alpharetta, GA (US); Walter Cooper Chastain, Atlanta, GA (US); Ari Craine, Marietta, GA (US); Robert Koch, Peachtree Corners, GA (US)

(21) Appl. No.: 17/491,973

(22) Filed: Oct. 1, 2021

(51) Int. Cl. G05D 1/00; G08G 1/095; B64C 39/02; G05D 1/10; G05D 1/02; G06Q 50/30

(52) U.S. Cl. CPC G05D 1/0088; G08G 1/095; B64C 39/024; G05D 1/104; G05D 1/0212; G05D 1/0291; G05D 1/0276; G06Q 50/30; B64C 2201/027; B64C 2201/12; B64C 2201/141

(57) ABSTRACT

A processing system including at least one processor may detect a loss of power event for a managed area, where the managed area includes a plurality of infrastructure elements that rely upon electric power grid power, and where the plurality of infrastructure elements provides a plurality of infrastructure services. The processing system may then identify at least one vehicle that is capable of providing at least one of the plurality of infrastructure services, where the at least one vehicle comprises an autonomous vehicle, and transmit an instruction to the at least one vehicle to deploy to a location of at least one of the plurality of infrastructure elements to provide the at least one of the plurality of infrastructure services.

The present disclosure relates generally to autonomous vehicle operations, and more particularly to methods, computer-readable media, and apparatuses for deploying an autonomous vehicle to a location of an infrastructure element to provide an infrastructure service in response to a loss of power event.

### BACKGROUND

Current trends in wireless technology are leading towards a future where virtually any object can be network enabled and network addressable, e.g., Internet Protocol (IP) addressable. The pervasive presence of wireless networks, including cellular, Wi-Fi, ZigBee, satellite and Bluetooth networks, and the migration to a 128-bit IPv6-based address space provides the tools and resources for the paradigm of the Internet of Things (IoT) to become a reality. In addition, drones or autonomous aerial vehicles (AAVs), which were once primarily recreational or experimental items, are increasingly being utilized for a variety of commercial and other useful tasks, such as package deliveries, search and rescue, mapping, surveying, and so forth.

### SUMMARY

In one example, the present disclosure describes a method, computer-readable medium, and apparatus for deploying an autonomous vehicle to a location of an infrastructure element to provide an infrastructure service in response to a loss of power event. For instance, in one example, a processing system including at least one processor may detect a loss of power event for a managed area, where the managed area includes a plurality of infrastructure elements that rely upon electric power grid power, and where the plurality of infrastructure elements provides a plurality of infrastructure services. The processing system may then identify at least one vehicle that is capable of providing at least one of the plurality of infrastructure services, where the at least one vehicle comprises an autonomous vehicle, and transmit an instruction to the at least one vehicle to deploy to a location of at least one of the plurality of infrastructure elements to provide the at least one of the plurality of infrastructure services.

### BRIEF DESCRIPTION OF THE DRAWINGS

The teaching of the present disclosure can be readily understood by considering the following detailed description in conjunction with the accompanying drawings, in which:

FIG. 1 illustrates an example system related to the present disclosure;

FIG. 2 illustrates examples of a vehicle status database and a task database, in accordance with the present disclosure;

FIG. 3 illustrates a flowchart of an example method for deploying an autonomous vehicle to a location of an infrastructure element to provide an infrastructure service in response to a loss of power event; and

FIG. 4 illustrates an example high-level block diagram of a computing device specifically programmed to perform the steps, functions, blocks, and/or operations described herein.

To facilitate understanding, identical reference numerals have been used, where possible, to designate identical elements that are common to the figures.

### DETAILED DESCRIPTION

Examples of the present disclosure describe methods, computer-readable media, and apparatuses for deploying an autonomous vehicle to a location of an infrastructure element to provide an infrastructure service in response to a loss of power event. In one example, the present disclosure provides a coordinated system to assemble one or more mobile devices (e.g., autonomous vehicles) with electronic capabilities that may be used to provide services to an area or location (e.g., a managed area with defined infrastructure services) in response to power failure events. The infrastructure services to be provided may be defined and broadcast to one or more candidate vehicles that may move to one or more locations within the managed area to provide the services. In one example, candidate devices may determine whether to accept a task offering in light of other tasks that the candidate devices may also be able to perform at the same time. In one example, a vehicle may promote its own capabilities in order to be a preferred provider of an infrastructure service. In particular, the vehicle is mobile and may move either autonomously or by control of a user or other entities. When the vehicle is either in a geographic zone or can be made to be in a geographic zone, the vehicle may make its capabilities known and submit requests to obtain the responsibility for performing a task, or infrastructure service, within the managed area at a given time.

A managed area may be defined by a set of location coordinates, such as Global Positioning System (GPS) coordinates. In one example, the coordinates may be in the form of latitude, longitude, and altitude values. At any given point in time, there may exist within the managed area a number of fixed devices or systems (e.g., infrastructure elements) that may have sensing and other enabling electronic capabilities such as video cameras, thermal cameras, light detection and ranging (LiDAR) sensors, sonar sensors, microphones, and environmental sensors (such as thermometers, barometers, humidity sensors, motion sensors, etc.). There may also be similarly-capable network-connected vehicles that may be transient within the managed area. These vehicles may also have other capabilities such as being configured to provide data connectivity as a temporary network node, having the ability to supply power, including lighting elements to provide area or targeted illumination and/or to operate as a traffic signal, to deliver an asset in the form of a payload, and so on. In one example, some vehicles may be transported to a location by other vehicles (e.g., a ground vehicle (autonomous or non-autonomous) may deliver multiple aerial vehicles such as uncrewed aerial vehicles (UAVs), which in one example, may comprise autonomous aerial vehicles (AAVs)). At a point in time, one or more of the candidate vehicles may exist within the managed area. At the same time, other candidate vehicles may not be present within the managed area, but may be in transit to the managed area. Also at the same time, still other candidate vehicles may be nearby the managed area, but may not be traveling on a route that would enter the managed area.

The candidate vehicles may continually update their statuses, which may be maintained by a fleet management system in a vehicle status database. Within the database, each vehicle may have a record, which may contain entries such as: vehicle identifier (ID), current location, planned route, vehicle capabilities, references, mobility range, and so forth. The capabilities data may include what types of infrastructure services that a vehicle can provide, along with data describing the level of service that the vehicle can provide. Each vehicle may register one or more capabilities.

In accordance with the present disclosure, the fleet management system may detect a power failure event for the managed area (e.g., all or a portion of the managed area). For instance, the fleet management system may maintain ground network-based communication with various infrastructure elements in the managed area (e.g., street lights, traffic lights, etc.) and may periodically transmit packets/messages (e.g., ping, keep-alive, etc.) to determine statuses and to maintain the connectivity or the ability to establish a connection. In the event that one or more of the infrastructure elements become unreachable or non-responsive, the fleet management system may determine that a power failure event has occurred. Alternatively, or in addition, the fleet management system may maintain a dedicated sensor device in the managed area to provide power status indications over the ground network or via wireless link(s). For instance, the sensor device may include a backup power source to enable wireless transmission of power status message(s) in the event of power loss from an electric power distribution system (e.g., the electric power grid). In still another example, the fleet management system may subscribe to and receive power outage messages from an operator of an electric power distribution system. In one example, the fleet management system may comprise one or more servers that are not located in the managed area, or may be deployed on public and/or private cloud computing infrastructure with geographic redundancies. The fleet management system may maintain an infrastructure database containing infrastructure element IDs, element types and/or the functions/infrastructure services of the infrastructure elements, locations of infrastructure elements (which may include altitude), status information of the infrastructure elements, and/or other data pertaining to the infrastructure elements, such as backup power capability, and so on.

In one example, in response to a loss of power event, the fleet management system may generate one or more tasks comprising one or more infrastructure services to be provided at a specified location for a specified period of time. The fleet management system may also scan the vehicle status database to determine one or more candidate vehicles that may potentially provide the task(s)/infrastructure service(s). In one example, the managed area may represent an area of a city or a town. The managed area may normally be served by security cameras, street lights, traffic lights, and network access points and/or edge nodes, among other powered utilities. In the event of a power failure, these capabilities may be provided temporarily by one or more capable vehicles. For instance, in response to a power failure/loss of power event, the fleet management system may identify affected infrastructure elements, and may identify and assign vehicles to fulfill the corresponding task(s)/infrastructure service(s). For example, the fleet management system may determine that one or more locations within the managed area have network wireless access points with loss of power and hence loss of wireless network connectivity, and similarly with respect to security cameras, traffic camera, traffic signals (e.g., traffic lights), and so forth. To illustrate, one task may be to provide a best resolution continuous video and audio feed from a location within the managed area for an estimated 2 hours, beginning as soon as possible. In one example, three elements of the task are established: (1) capability, (2) location, and (3) time.

Given the parameters of the task, the fleet management system may query the vehicle status database to identify which vehicles may satisfy the parameters. In this case, the timing may be “as soon as possible,” and only vehicles within the managed area, or currently within a certain range of the manage area, may be considered. For instance, if a UAV is determined to be within a threshold distance from the managed area and with no intended route, it may be a candidate for the task. If a ground-based autonomous vehicle (AV) is on a route that will go near the managed area, the AV may also be a candidate, and so on. Upon determining the list of candidate vehicles for the task, the fleet management system may broadcast an offer for the task to the candidate vehicles. Alternatively, the fleet management system may send the offer to all vehicles within an area which may be larger than the managed area so as to include nearby locations. In one example, the fleet management system may send, along with the offer of the task, an incentive to each vehicle for performing the task. The incentive may be an exchange of electronic value, such as an electronic payment that would be credited to an account associated with the vehicle in the vehicle status database or via an external exchange system. The incentive may vary based on the capabilities and level of service as registered by each vehicle in the vehicle status database. For instance, the fleet management system may send a more favorable incentive to a particular UAV than to other vehicles if that particular UAV has a higher resolution camera with greater range. However, the incentive sent with the offer to UAV 1 may be the same as that to UAV 2, if they have comparable capabilities.

Upon receiving an offer to perform a task along with an incentive, a vehicle (e.g., a ground-based AV or autonomous aerial vehicle (AAV)) may make a decision as to whether to promote itself to accept the task. This self-promotion may be necessary since the offer may have been made by the fleet management system to more vehicles than will end up being assigned the task. The vehicle may determine whether to promote itself for the tasks based on a number of factors, including whether the vehicle is currently committed to another task, whether the vehicle has more than one offer that would create a conflict, such as overlapping time periods, or based on how far the task location is from a home location of the vehicle. For instance, two task offers sent to a UAV may both also include data indicating the originators of the tasks; that is, who the UAV would be “working for.” The UAV may have a preferred client based on contractual or other factors, and may use that as a factor in determining whether to promote itself for the task assignment (e.g., a preference to provide infrastructure services to a city government instead of a private gated community). Upon determining to promote itself for a task assignment, the vehicle may send back to the fleet management system a response, including data describing the vehicle's ability to perform (or exceed) the requirements of the task. For instance, although the vehicle's capability data may be contained in the vehicle status database, the data may be incomplete, outdated, or the like. Thus, the vehicle may confirm its ability to perform the task. The vehicle may also indicate an acceptance of the incentive (or include a counter-offer, e.g., offering to accept a lower incentive to win the bid, or requesting a higher incentive in order to accept the assignment). The vehicle may also include data representing references that confirm the vehicle to be a trusted provider (e.g., other autonomous vehicles that may have worked with the vehicle in the past and can confirm task performance).

Upon receiving one or more promotions for the task, the fleet management system may assign one or more vehicles to perform the task. Each vehicle's abilities to perform the task may vary, but they may collectively contribute to performing the overall task. For instance, vehicle 1 may only be available in the location for an estimated 30 minutes, which may promote itself to provide 30 minutes of coverage along a predicted route within the managed area, for less than the incentive offered. Alternatively, or in addition, the task may involve assignment of one AV to provide electrical power services, and one or more other AVs to operate as street/path lights, traffic signal(s) and so forth. For instance, smaller AAVs may be dispatched to operate as path lights and may be configured or loaded with code, instructions, and so forth to periodically recharge from a larger ground-based AV that may have a much larger battery. In another example, a user associated with a vehicle (e.g., an operator of a non-autonomous vehicle, or an owner, operator, or manager of an AV) may be prompted to alter a planned route for the AV to either go to task location within the managed area, or to spend more time in the managed area than planned. In this case, the vehicle may prompt the user to determine whether the vehicle should promote itself for a task assignment. The prompt may be presented in a user-friendly format, such as an audible or visual prompt via a smartphone or other mobile computing devices associated with the user. The user may reply, for instance, via a voice command, a touch input via a keyboard, mouse, touchscreen or the like, and so forth.

In another type of user interaction, a user may be associated with a device that serves as a vehicle's “contact person” in the vehicle status database. In this case, the user may view any task offers and incentives and decide whether to make a promotion for the vehicle to perform the task. Upon the receipt of all vehicle promotions, the fleet management system may decide on task assignment(s) based on factors such as which vehicles can offer better levels of service, are available for a longer period of time, are deemed to be more reliable, or can arrive more quickly. The fleet management system may send task assignments to each selected vehicle, specifying where to go, how long to be there, and what infrastructure service(s) to provide. In one example, when a decision is made among competing bids, the fleet management system may assign the task by marking the task as “assigned” and noting the AV(s) assigned the task, any value/incentive agreed upon, etc., and may notify the AVs accordingly. In addition, the AV(s) assigned to the task may be marked as “on task” in the vehicle status database. For instance, other new tasks that may be in conflict with the current assigned task may not be presented to AVs that are “on task” at a same or overlapping time.

In one example, members (e.g., AVs or non-autonomous AVs) of the fleet may be all known and trusted by the fleet management system and stored in the vehicle status database. In one example, AVs of the fleet may be owned and/or operated by a same entity or organization as the fleet management system. For instance, a fleet management system may be owned and/or operated by a city, which may also own and/or operate AVs within the fleet. In one example, the infrastructure database may include for each infrastructure element, one or more AVs that are assigned or that are assignable to the infrastructure element. For instance, there may be one or more road intersections that are determined to be of sufficient importance such that traffic signal services should be restored as soon as possible after a power loss event. In such case, one or more AVs may have a pre-established relationship or assignment to provide a traffic signal service to replace a traffic signal at the given road intersection. In one example, the vehicle status database may also include data describing a vehicle's assignment to one or more particular infrastructure elements in the managed area. Other AVs may similarly be pre-assigned to provide street/path lighting in replacement of specific street/path lights, and so on. In another example, the AVs may have other primary tasks, such as a ground-based AV that is tasked with litter cleanup, but which may be reassigned to more critical infrastructure services. For instance, the AV tasked with litter cleanup may have capabilities to operate as a traffic signal and may be reassigned to a location for such purpose. For example, the AV may have traffic signal lights that may be activated and that may be programmed, or that are programmable to operate according to the same or similar pattern as a traffic signal for which the AV is being substituted. Thus, the AV may position itself within the intersection and activate its traffic signal lights accordingly. After the power is restored or after the AV is replaced by another AV as a temporary traffic signal, the AV may return to its primary task of litter cleanup, for example.

Alternatively, or in addition, AVs may be independently owned and operated, but may be registered by the fleet management system, entered into the vehicle status database, and may then be eligible to potentially obtain task assignments from the fleet management system. For instance, in one example, an unknown AV may attempt to register in the vehicle status database in an ad hoc manner. For example, the unknown AV may be able to perform a task while it is within or near the managed area. The fleet management system may broadcast its willingness to accept unknown AVs on an ad hoc basis, e.g., via its registration process. In doing so, the fleet management system may include minimum requirements that must be met for an AV to attempt to register. An unknown AV may send a registration attempt to the fleet management system and it may be accepted or not accepted based on an analysis of the capabilities that the unknown AV asserts and any vetting performed by the fleet management system (e.g., reference checks with other fleet management systems of other entities, security verifications such as any required security software being deployed or verification of up-to-date software updates, and the like). In one example, an AV may independently engage assistance from another AV to acquire the necessary skills, resources and/or capabilities to perform or to compete for a task.

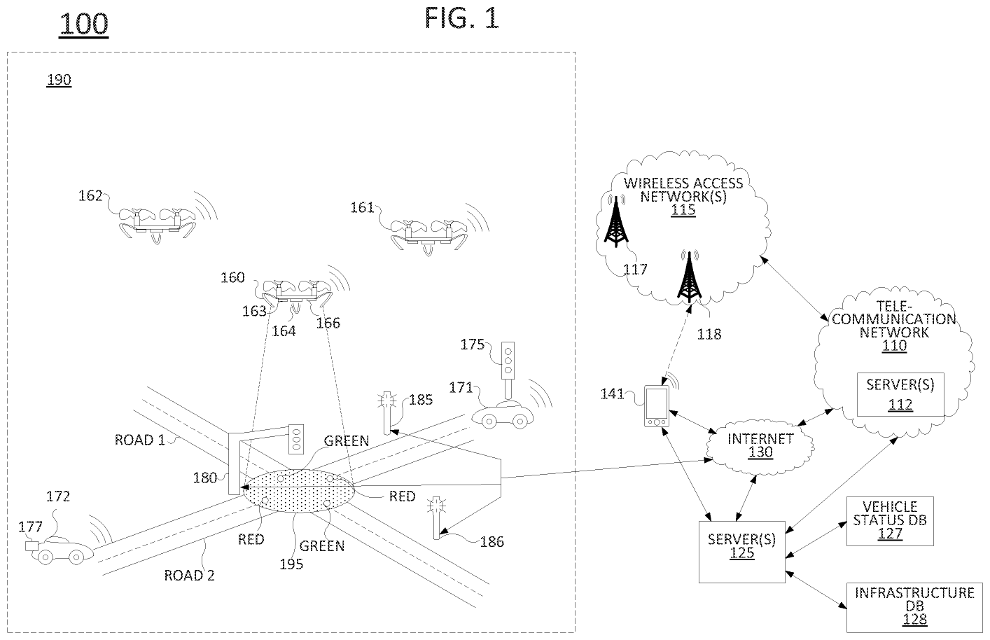

Thus, the present examples describe a fleet management system that is able to detect power failure events, identify infrastructure elements for which infrastructure services are to be replaced, identify available AVs, assign tasks/infrastructure services to such AVs, and so on. It should be noted that for illustrative purposes the present disclosure is described primarily in connection with examples of autonomous aerial vehicles (AAV). However, each of the described examples may be equally applicable to other types of AVs, such as autonomous submersibles, autonomous land surface travelling vehicles, autonomous water surface travelling vehicles (e.g., boats, hydrofoils, hovercraft, etc.). These and other aspects of the present disclosure are discussed in greater detail below in connection with the examples of FIGS. 1-4.

To aid in understanding the present disclosure, FIG. 1 illustrates an example system 100, related to the present disclosure. As shown in FIG. 1, the system 100 connects user device 141, server(s) 112, server(s) 125, autonomous aerial vehicles (AAVs 160-162), autonomous vehicles (AVs) 171 and 172, traffic signal 180, and path lights 185 and 186 with one another and with various other devices via a core network, e.g., a telecommunication network 110, a wireless access network 115 (e.g., a cellular network), and Internet 130.

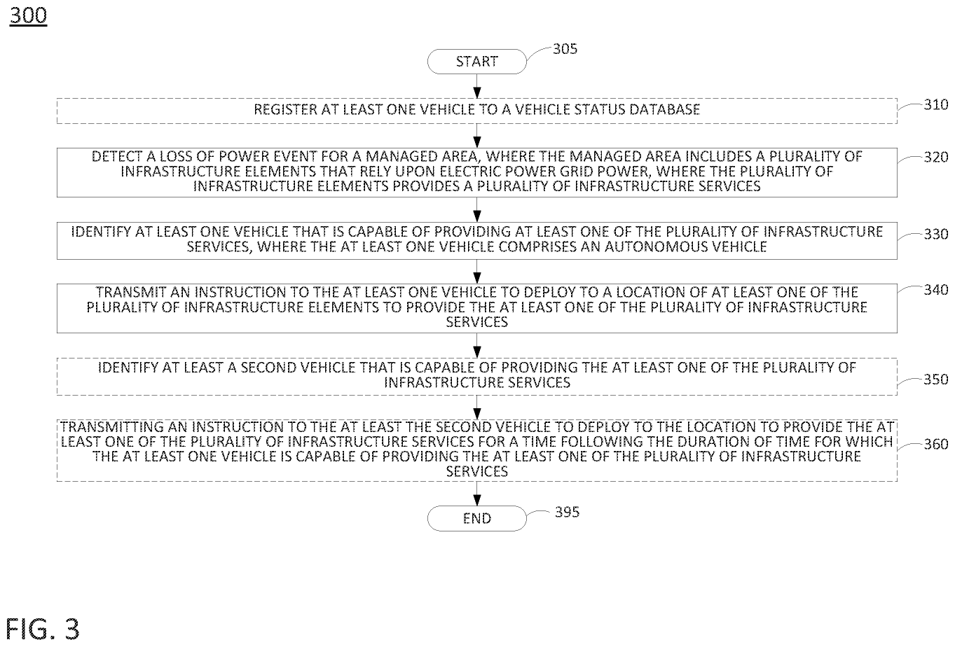

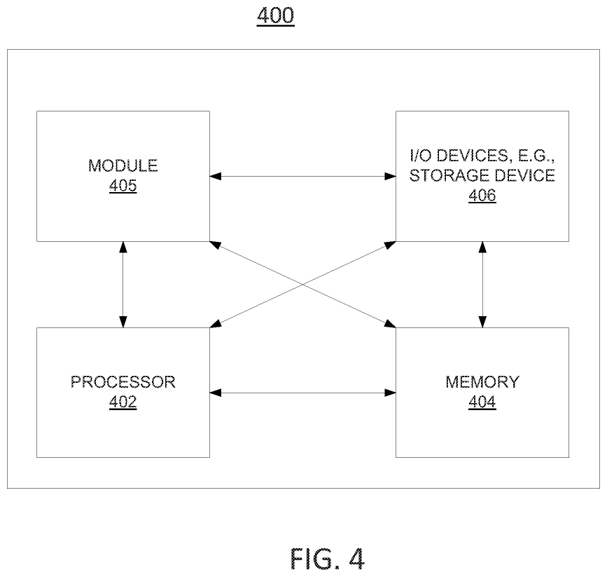

In one example, the server(s) 125 may each comprise a computing device or processing system, such as computing system 400 depicted in FIG. 4, and may be configured to perform one or more steps, functions, or operations for deploying an autonomous vehicle to a location of an infrastructure element to provide an infrastructure service in response to a loss of power event. For instance, an example method for deploying an autonomous vehicle to a location of an infrastructure element to provide an infrastructure service in response to a loss of power event is illustrated in FIG. 3 and described below. In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device, or computing system, including one or more processors, or cores (e.g., as illustrated in FIG. 4 and discussed below) or multiple computing devices collectively configured to perform various steps, functions, and/or operations in accordance with the present disclosure.

In one example, server(s) 125 may comprise, or be coupled to or in communication with a vehicle status database 127 and an infrastructure database 128. For instance, the server(s) 112, or server(s) 125 in conjunction with vehicle status database 127 and an infrastructure database 128 may comprise a fleet management system in accordance with the present disclosure. In one example, vehicle status database 127 and infrastructure database 128 may represent a distributed file system, e.g., a Hadoop® Distributed File System (HDFS™), or the like. Server(s) 125 may receive and store information regarding AVs in vehicle status database 127, such as, for each AV: an identifier of the AV, a maximum operational range of the AV, a current operational range of the AV, capabilities or features of the AV, such as maneuvering capabilities, payload/lift capabilities (e.g., including maximum weight, volume, etc.), sensor and recording capabilities, lighting capabilities (e.g., traffic signal lighting and/or area lighting), visual projection capabilities, sound broadcast capabilities, and so forth, availability status of the AV (e.g., whether it is idle, whether it has sufficient charge, fuel, or other power capacities, whether it can be re-tasked to provide infrastructure services as described herein, whether it is within the managed area 190 or is within a certain distance or time-of-travel from the managed area 190, etc.). In one example, an AV may register itself with server(s) 125 over a network when an AV becomes active and is within communication range of network access point(s) covering the managed area 190 (e.g., base stations 117 and/or 118), or may be accomplished by an AV owner or operator at another time. Server(s) 125 may include AVs in the fleet on a permanent, temporary, or provisional basis. The vehicle status database 127 may also store information regarding assignments of AVs in the fleet to various tasks/infrastructure services, reputation/trust level information regarding various AVs, and so on.

Server(s) 125 may store in the infrastructure database 128, infrastructure element IDs, element types and/or the functions/infrastructure services of the infrastructure elements, locations of infrastructure elements (which may include altitude), status information of the infrastructure elements, and/or other data pertaining to the infrastructure elements, such as backup power capabilities, and so forth. For instance, infrastructure elements of managed area 190, may include traffic signal 180, as well as street/path lights 185 and 186. Various other infrastructure elements, each providing one or more corresponding infrastructure services, may include traffic cameras, information boards, such as an electronic information board that provides a bus schedule, estimated arrival time of a next bus (e.g., including on-time information), and so on.

In one example, the system 100 includes a telecommunication network 110. In one example, telecommunication network 110 may comprise a core network, a backbone network or transport network, such as an Internet Protocol (IP)/multi-protocol label switching (MPLS) network, where label switched routes (LSRs) can be assigned for routing Transmission Control Protocol (TCP)/IP packets, User Datagram Protocol (UDP)/IP packets, and other types of protocol data units (PDUs), and so forth. It should be noted that an IP network is broadly defined as a network that uses Internet Protocol to exchange data packets. However, it will be appreciated that the present disclosure is equally applicable to other types of data units and transport protocols, such as Frame Relay, and Asynchronous Transfer Mode (ATM). In one example, the telecommunication network 110 uses a network function virtualization infrastructure (NFVI), e.g., host devices or servers that are available as host devices to host virtual machines comprising virtual network functions (VNFs). In other words, at least a portion of the telecommunication network 110 may incorporate software-defined network (SDN) components.

As shown in FIG. 1, telecommunication network 110 may also include one or more servers 112. In one example, each of the server(s) 112 may comprise a computing device or processing system, such as computing system 400 depicted in FIG. 4 and may be configured to provide one or more functions for deploying an autonomous vehicle to a location of an infrastructure element to provide an infrastructure service in response to a loss of power event, in accordance with the present disclosure. For example, one or more of the server(s) 112 may be configured to perform one or more steps, functions, or operations in connection with the example method 300 described below. In one example, server(s) 112 may perform the same or similar functions as server(s) 125. For instance, telecommunication network 110 may provide a fleet management system, e.g., as a service to one or more subscribers/customers, in addition to telephony services, data communication services, television services, etc. For ease of illustration, various additional elements of telecommunication network 110 are omitted from FIG. 1.

In one example, one or more wireless access networks 115 may each comprise a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, wireless access network(s) 115 may each comprise an access network in accordance with any “second generation” (2G), “third generation” (3G), “fourth generation” (4G), Long Term Evolution (LTE), “fifth generation” (5G), or any other existing or yet to be developed future wireless/cellular network technology. While the present disclosure is not limited to any particular type of wireless access network, in the illustrative example, base stations 117 and 118 may each comprise a Node B, evolved Node B (eNodeB), or gNodeB (gNB), or any combination thereof providing a multi-generational/multi-technology-capable base station. In the present example, user device 141, AAVs 160-162, and AVs 171-172 may be in communication with base stations 117 and 118, which provide connectivity between AAVs 160-162, AVs 171-172, user device 141, and other endpoint devices within the system 100, various network-based devices, such as server(s) 112, server(s) 125, and so forth. In one example, wireless access network(s) 115 may be operated by the same service provider that is operating telecommunication network 110, or one or more other service providers.

As illustrated in FIG. 1, user device 141 may comprise, for example, a cellular telephone, a smartphone, a tablet computing device, a laptop computer, a desktop computer, a wireless enabled wristwatch, or any other wireless and/or cellular-capable mobile telephony and computing devices (broadly, a “mobile device” or “mobile endpoint device”). In one example, user device 141 may instead comprise a cloud desktop, or the like, wherein the “user device” may comprise network-based computing resources that are allocated to a user and which may provide for an operating system and a suite of applications which may provide similar functions to a desktop computer, a laptop computer, a mobile computing device, etc. In one example, user device 141 may be equipped for cellular and non-cellular wireless communication. For instance, user device 141 may include components which support peer-to-peer and/or short range wireless communications. Thus, user device 141 may include one or more radio frequency (RF) transceivers, e.g., for cellular communications and/or for non-cellular wireless communications, such as for IEEE 802.11 based communications (e.g., Wi-Fi, Wi-Fi Direct), IEEE 802.15 based communications (e.g., Bluetooth, Bluetooth Low Energy (BLE), and/or ZigBee communications), and so forth.

In accordance with the present disclosure, AAV 160 may include a camera 163 and one or more radio frequency (RF) transceivers 166 for cellular communications and/or for non-cellular wireless communications. In one example, AAV 160 may also include one or more module(s) 164 with one or more additional controllable components, such as a microphone, a loudspeaker, an infrared, ultraviolet, or visible spectrum light source, a projector, a light detection and ranging (LiDAR) unit, a temperature sensor (e.g., a thermometer), a traffic signal unit, and so forth. It should be noted that AAVs 161 and 162 may be similarly equipped. However, for ease of illustration, specific labels for such components of AAV 161 and AAV 162 are omitted from FIG. 1. In addition, AVs 171 and 172 may similarly be equipped with transceivers for cellular or non-cellular wireless communication, various modules with sensors or other controllable components, etc. For example, AV 171 may include a traffic signal unit 175, while AV 172 may include an extra battery unit 177.

In addition, each of the AAVs 160-162 and AVs 171-172 may include on-board processing systems to perform steps, functions, and/or operations in connection with examples of the present disclosure for deploying an autonomous vehicle to a location of an infrastructure element to provide an infrastructure service in response to a loss of power event, and for controlling various components of the respective AVs. For instance, AAVs 160-162, and/or AVs 171-172 may each comprise all or a portion of a computing device or processing system, such as computing system 400 as described in connection with FIG. 4 below, specifically configured to perform various steps, functions, and/or operations in connection with examples of the present disclosure for deploying an autonomous vehicle to a location of an infrastructure element to provide an infrastructure service in response to a loss of power event, such as described in connection with the example method 300 of FIG. 3.

In an illustrative example, server(s) 125 may detect a loss of power event (e.g., a loss of electric power from an electrical distribution network/system (e.g., the power grid)) in the managed area 190. The managed area 190 may comprise, for example, all or a portion of a town/city, a community (e.g., a housing development or neighborhood), or the like. In one example, the managed area 190 may include a number of infrastructure elements that may be managed by a responsible entity (such as a department of public safety, public works, etc.), a community property manager, and so forth. In accordance with the present disclosure, infrastructure elements include infrastructure elements that rely upon electric power from an electric power system (e.g., the electric grid) for operation, such as camera, traffic signals, street/path lights, public information screens, and so forth. In one example, at least some of the infrastructure elements may also be network-connected. For instance, as illustrated in FIG. 1, traffic signal 180, and street/path lights 185 and 186 all include wired network connectivity, e.g., via Internet 130.

Server(s) 125 may detect the loss of power event in various ways. For example, server(s) 125 may maintain communication with various infrastructure elements in the managed area 190 (e.g. via Internet 130 and/or other networks such as telecommunication network 110, etc.). In the event that one or more of the infrastructure elements become unreachable or non-responsive, server(s) 125 may determine that a power failure event has occurred. Alternatively, or in addition, server(s) 125 may maintain a dedicated sensor device (not shown) in the managed area 190 to provide power status indications, e.g., via Internet 130 and/or via wireless access network(s) 115, telecommunication network 110, etc. For instance, the sensor device may include a backup power source to enable wireless transmission of power status message(s) in the event of power loss from the electric grid. In still another example, server(s) 125 may subscribe to and receive power outage messages from an operator of an electric power distribution system for the managed area 190.

In response to the detection of the power failure event in the managed area 190, server(s) 125 may identify infrastructure elements in the managed area 190 that may have infrastructure services to be replaced by available vehicles (e.g., AVs). In one example, if the server(s) 125 have localized power outage information, then the location(s) of infrastructure services to be replaced may be less than all of the managed area 190. If the power outage is widespread, or more information on precise location(s) is not available, then server(s) 125 may consider the entire managed area 190 for potential temporary infrastructure service replacement. In such case, vehicles may be identified for service and dispatched to one or more locations. However, if upon arrival at a location the vehicle may determine that the fixed or normally assigned infrastructure elements appear to have electrical power, the vehicle may notify the server(s) 125, whereupon the vehicle may be released from the assigned task, and in one example may be reassigned to provide an infrastructure service at a different location in the managed area 190 (and similarly for any other vehicles that may have been assigned to the location). In this regard, one or more vehicles may include image/video processing capabilities to identify if an area is with or without electric power.

For instance, a machine learning model (MLM) based classifier may be trained on images and/or video to distinguish between whether an image and/or video is indicative of an area with or without power. For example, the identification of areas with/without power be performed in accordance with a machine learning algorithms (MLA), e.g., a trained (MLM) comprising a classifier. For instance, the MLA (or the trained MLM) may comprise a deep learning neural network, or deep neural network (DNN), a generative adversarial network (GAN), a support vector machine (SVM), e.g., a binary, non-binary, or multi-class classifier, a linear or non-linear classifier, and so forth. In one example, the MLA may incorporate an exponential smoothing algorithm (such as double exponential smoothing, triple exponential smoothing, e.g., Holt-Winters smoothing, and so forth), reinforcement learning (e.g., using positive and negative examples after deployment as a MLM), and so forth. It should be noted that various other types of MLAs and/or MLMs may be implemented in examples of the present disclosure, such as a kernel-based SVM, a distance-based classifier, e.g., a Euclidean distance-based classifier, and so on.

The MLA may utilize visual features from a camera, a LiDAR unit, or the like (such as camera 163 and/or module 164 of AAV 160) for detection and recognition of loss of power areas (and conversely areas with electrical power). In other words, the features upon which an MLA/classifier may be trained may include low-level invariant image data, such as colors (e.g., RGB (red-green-blue) or CYM (cyan-yellow-magenta) raw data (luminance values) from a CCD/photo-sensor array), shapes, color moments, color histograms, edge distribution histograms, etc. Visual features may also relate to movement in a video and may include changes within images and between images in a sequence (e.g., video frames or a sequence of still image shots), such as color histogram differences or a change in color distribution, edge change ratios, standard deviation of pixel intensities, contrast, average brightness, and the like.

In the example of FIG. 1, server(s) 125 may identify in the infrastructure database 128 that traffic signal 180 is within managed area 190 and is affected by the power loss event. Server(s) 125 may also obtain from infrastructure database 128 the location of the traffic signal 180 (e.g., the intersection 195, which may be identified by geographic coordinates, or alternatively or additional by street address/intersection, geographic information system (GIS) grid identification, or the like), and the corresponding infrastructure service (e.g., a traffic signal service). Server(s) 125 may next identify candidate vehicles (e.g., AVs) from the vehicle status database 127 that may be able to provide the infrastructure service. For instance, in one example, the infrastructure database 128 and/or the vehicle status database 127 may identify specific AVs that may be associated with the traffic signal 180. For instance, one or more AVs may be pre-assigned to the traffic signal 180 as a backup, or backups (e.g., “first-choice” backup(s)). In another example, AVs may be registered in the vehicle status database 127 has having one or more capabilities to provide one or more infrastructure services. In addition, server(s) 125 may determine current locations, availability statuses, and so forth for the AVs, and may transmit offers to one or several of the AVs to provide such infrastructure services. In another example, server(s) 125 may broadcast offers in an area to be received by any AVs registered and in range to receive the broadcasts (e.g., via base stations 117 and 118). In one example, server(s) 125 may communicate with first-choice/pre-assigned AVs to verify availability and/or statuses, and may transmit offers to other AVs in the event that any first-choice/pre-assigned AVs are not able to fulfill their roles. In one example, offers may be transmitted to registered owners, operators, or other individuals or entities responsible for AVs, or may be forwarded to such persons from the respective AVs receiving the offers. For instance, mobile device 141 may be associated with an owner of AV 171 which may receive and provide responses to any offers from the server(s) 125 for AV 171 to provide infrastructure services.

In the example illustrated in FIG. 1, AAV 160 may be pre-assigned or may be selected to provide a traffic signal infrastructure service to replace the traffic signal 180. For instance, server(s) 125 may transmit instructions to AAV 160 to deploy itself to the location of the traffic signal 180 as identified from the infrastructure database 128. In one example, AAV 160 may be pre-configured to provide the traffic signal service at the intersection 195. For instance, AAV 160 may already include code, instructions, or the like to enable AAV 160 to provide traffic signal lights in the proper locations at or within the intersection 195, and properly timed for the intersection 195. In another example, server(s) 125 may obtain the code, instructions, or the like from the infrastructure database 128 and provide this data to AAV 160, e.g., when AAV 160 is selected by server(s) 125 and assigned to provide the infrastructure service of traffic signal 180.

As shown in FIG. 1, AAV 160 may navigate to the intersection 195 and may provide a temporary traffic signal service projecting red, yellow, and green lights at selected points within the intersection. It should be noted that the instance captured in the depiction of FIG. 1 may relate to when traffic is cleared to travel along road 1 (green lights) and traffic along road 2 is held at a stop (red lights). In one example, AAV 160 may change the light pattern with the same or similar timing as the traffic signal 180 that is temporarily being replaced. In one example, the use of AVs for backup infrastructure services (in particular, for traffic signals) may be accompanied by a public awareness campaign and potential traffic laws requiring that motorists reduce speed and use extra caution in and around affected intersections.

Server(s) 125 may assign AAV 160 to provide a traffic signal service at intersection 195 for a defined period of time, which in one example may be based upon information in the infrastructure database 128 and/or information obtained from AAV 160 indicating the operational capacity of AAV 160 (e.g., how long AAV 160 is able to operate before needing a recharge, refuel, etc.). In one example, server(s) 125 may determine that a loss of power event has ended (e.g., electric power is restored to the grid in the managed area 190 or the relevant portion thereof). For instance, the restoration of power may be detected when messages are received from infrastructure elements indicating that such infrastructure elements are back online, may be detected via a dedicated sensor in the managed area 190, may be detected from a message from an operator of the electric power distribution system, and so forth. In response to detecting the restoration of electric power, server(s) 125 may transmit an instruction to AAV 160 (e.g., via wireless access network(s) 115) to cease providing the traffic signal service (and similarly for any other AVs that may have been assigned to provide infrastructure services in the managed area 190). In one example, AAV 160 or an owner or operator thereof may obtain a value item in exchange for providing the infrastructure service (such as monetary compensation to an electronic bank account, or similar credit). In one example, server(s) 125 may record information to the vehicle status database 127 and/or the infrastructure database 128 indicating a successful deployment of AAV 160 to provide the traffic signal service. For instance, a level of trust or service level of the AAV 160 may be increased such that AAV 160 may be more likely to be selected to provide a traffic signal service or other infrastructure services in the future, may receive additional consideration as an incentive to provide an infrastructure service in the future, and so forth. In other words, server(s) 125 may favor more trusted AVs that may have performed well in the past.

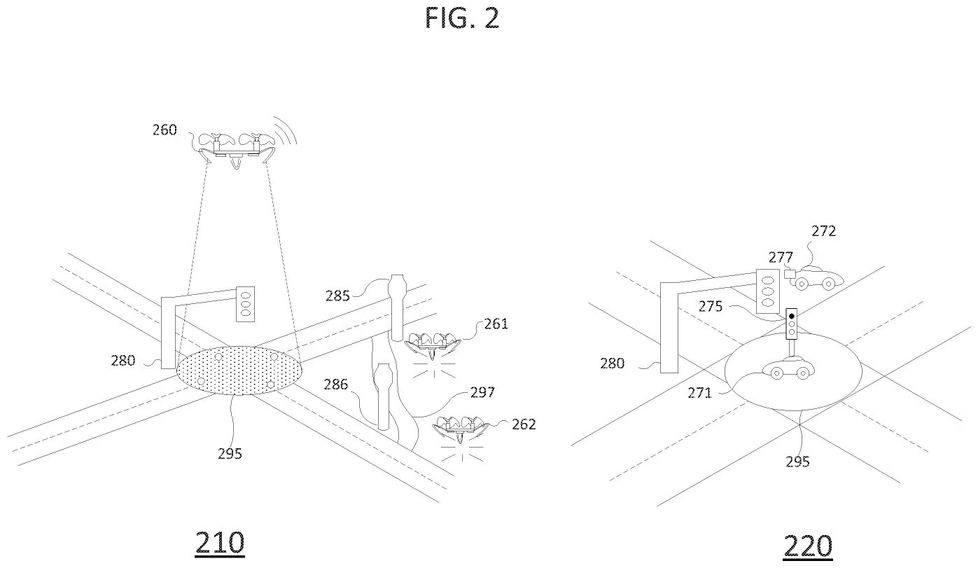

It should be noted that FIG. 1 illustrates just one example of an AV (e.g., AAV 160) providing an infrastructure service in response to a loss of power event. In this regard, FIG. 2 illustrates additional scenarios with reference to the same or similar AVs shown in FIG. 1. In addition, the foregoing illustrates just one example of a system in which examples of the present disclosure for deploying an autonomous vehicle to a location of an infrastructure element to provide an infrastructure service in response to a loss of power event may operate. In addition, the foregoing is described in connection with just one example infrastructure service. However, it will be appreciated that various other infrastructure services may be performed by at least one AV, such as a visual projection or electronic signage task, a lighting projection task, and so forth.

It should also be noted that the system 100 has been simplified. In other words, the system 100 may be implemented in a different form than that illustrated in FIG. 1. For example, the system 100 may be expanded to include additional networks, and additional network elements (not shown) such as wireless transceivers and/or base stations, border elements, routers, switches, policy servers, security devices, gateways, a network operations center (NOC), a content distribution network (CDN) and the like, without altering the scope of the present disclosure. In addition, system 100 may be altered to omit various elements, substitute elements for devices that perform the same or similar functions and/or combine elements that are illustrated as separate devices.

As just one example, one or more operations described above with respect to server(s) 125 may alternatively or additionally be performed by server(s) 112, and vice versa. In addition, although server(s) 112 and 125 are illustrated in the example of FIG. 1, in other, further, and different examples, the same or similar functions may be distributed among multiple other devices and/or systems within the telecommunication network 110, wireless access network(s) 115, and/or the system 100 in general that may collectively provide various services in connection with examples of the present disclosure for deploying an autonomous vehicle to a location of an infrastructure element to provide an infrastructure service in response to a loss of power event. Additionally, devices that are illustrated and/or described as using one form of communication (such as a cellular or non-cellular wireless communications, wired communications, etc.) may alternatively or additionally utilize one or more other forms of communication. In still another example, there may be various different servers providing temporary replacement of infrastructure services for different managed areas. For example, a first server and a first fleet of vehicles may be associated with a first city, a second server and a second fleet of vehicles may be associated with a second city, a third server and a third fleet of vehicles may be associated with a private community, and so forth. Thus, these and other modifications are all contemplated within the scope of the present disclosure.

FIG. 2 illustrates additional example scenarios 210 and 220 for deployment of AVs in response to power outage events. Aspects of FIG. 2 may be the same or similar to counterparts illustrated in FIG. 1. For instance, AAVs 260-262 may be the same or similar to AAVs 160-162 of FIG. 1. Traffic signal 280, street/path lights 285 and 286, and intersection 295 of FIG. 2 may be the same or similar to traffic signal 180, street/path lights 185 and 186, and intersection 195, respectively, of FIG. 1. In addition, AVs 271 and 272 and the components thereof may be the same or similar to corresponding AVs 171 and 172 of FIG. 1.

In scenario 210, AAV 260 may be assigned to provide a traffic signal service to the intersection 295, similar to the example of FIG. 1. However, in addition, street/path lights 285 and 286 may be determined to be without electric power in response to the loss of power event. As such, additional AVs, such as AAVs 261 and 262 may be identified, selected, and dispatched to the path 297 to provide a replacement path lighting service. For instance, AAVs 260-262 may each be dispatched by a fleet management system, such as server(s) 125 of FIG. 1. For example, each of AAVs 260-262 may be provided with separate instructions to deploy to a particular location and provide a respective infrastructure service in accordance with the capabilities of the respective AAVs 260-262. In one example, the instructions to AAVs 261 and 262 may include an altitude of the lighting to be provided, e.g., as close as safely practical to the heights of the lights 285 and 286 being replaced, an intensity of the light(s), the color(s) of the lights, and so forth. However, in one example, AAVs 261 and 262 may be instructed to use, or may be permitted to use ground-based deployment locations. For instance, because the temporary infrastructure services are being implemented in response to a loss of power event, it may also be beneficial for the AVs to conserve power use. As such, AAVs 261 and 262 may provide a longer duration of lighting service before needing a recharge than would be possible if AAVs 261 and 262 were required to maintain flight.

In one example, AAVs 260-262 may be instructed to collaborate. For instance, AAVs 260-262 may communicate via Wi-Fi Direct broadcast, LTE Direct, Dedicated Short Range Communications (DSRC), e.g., in the 5.9 MHz band, or the like, a 5G device-to-device (D2D) or vehicle-to-vehicle (V2V) sidelink, such as over a P5 interface, and so forth). In one example, AAV 261 may be instructed to replace AAV 260 to provide a traffic signal service when AAV 260 is low on battery charge, for example. Thus, for instance, AAV 260 may communicate to AAV 261 that AAV 260 may need to be relieved in order for AAV 260 to travel to a location where it can be recharged (which may be outside of the managed area affected by the loss of power event). Similarly, AAV 262 may be instructed to replace AAV 261 when a battery of AAV 261 is running low. In one example, these instructions may be provided to the AAVs 260-262 at the time(s) of initial dispatch or may be transmitted (e.g., by a fleet management system) in response to ongoing notifications of AV statuses from deployed AVs.

Scenario 220 illustrates an additional example in which a managed area including intersection 295 suffers a loss of power event, and in which AV 271 may be dispatched to the intersection 295 to provide a temporary traffic signal service to replace traffic signal 280. In this example, AV 271 may be specifically equipped to operate as a traffic signal (e.g., traffic signal unit 275). For instance, AV 271 may typically operate as an autonomous trash collector for a city, but may include the traffic signal unit 275 to enable AV 271 to be re-purposed in response to loss of power events. In the present example, AV 271 may be identified, selected, and dispatched (e.g., by a fleet management system, such as server(s) 125 of FIG. 1) to the intersection 295 to provide a replacement traffic signal service. For instance, AV 271 may navigate to the center of the intersection 295 and may activate the traffic signal unit 275. In one example, the fleet management system may provide configuration data to AV 271 to enable AV 271 to operate with a certain signal/light timing that is specific to the intersection 295. In another example, AV 271 may be preassigned to the intersection 295 (e.g., as recorded in an infrastructure database) and may already have the proper configuration data stored in an on-board memory and/or storage module at the time of assignment to the intersection 295 in response to a current loss of power event.

As further illustrated in the scenario 220, AV 272 may also be identified, selected, and dispatched (e.g., by a fleet management system, such as server(s) 125 of FIG. 1) to the intersection 295 to provide an additional service in support of the traffic signal service of AV 271. For instance, AV 272 may include an additional battery component 277 (e.g., a large-capacity battery-bank/module) that may be used to recharge various other AVs or other electronic devices. For instance, AV 271 may be relatively stationary while providing the traffic signal service and may use far less battery power than in AV 271 were operating in its primary capacity as a trash collector. However, over time, AV 271 may run low on battery charge/capacity. In this case, AV 271 may obtain additional battery power from the battery component 277 of AV 272 (e.g., by swapping a battery, or batteries, by recharging AV 271 via an electric power cable connected to the battery component 277, etc.). In one example, AVs 271 and 272 may receive instructions to collaborate (e.g., from a fleet management system) and may communicate with each other via Wi-Fi Direct broadcast, LTE Direct, DSRC, a 5G D2D or V2V sidelink, and so forth.

It should be noted that FIG. 2 illustrates just several additional representative examples, and that various other, further, and different examples may be demonstrated in accordance with the present disclosure. Similarly, various additional AVs and/or other components may be deployed, additional infrastructure services may be provided, and so forth. As just one further example, scenario 220 may be expanded to include an additional AV having a traffic signal unit that may take turns with AV 271 providing a traffic signal service to the intersection 295 in replacement of the traffic signal 280.

FIG. 3 illustrates a flowchart of an example method 300 for deploying an autonomous vehicle to a location of an infrastructure element to provide an infrastructure service in response to a loss of power event. In one example, steps, functions and/or operations of the method 300 may be performed by a device or apparatus as illustrated in FIG. 1, e.g., by one or more of server(s) 125 and/or server(s) 112, or any one or more components thereof, or by server(s) 125 or servers 112, and/or any one or more components thereof in conjunction with one or more other components of the system 100, such as elements of wireless access network 115, telecommunication network 110, AAVs 160-162, AVs 171-172, mobile device 141, and so forth. In one example, the steps, functions, or operations of method 300 may be performed by a computing device or processing system, such as computing system 400 and/or hardware processor element 402 as described in connection with FIG. 4 below. For instance, the computing system 400 may represent any one or more components of the system 100 that is/are configured to perform the steps, functions and/or operations of the method 300. Similarly, in one example, the steps, functions, or operations of the method 300 may be performed by a processing system comprising one or more computing devices collectively configured to perform various steps, functions, and/or operations of the method 300. For instance, multiple instances of the computing system 400 may collectively function as a processing system. For illustrative purposes, the method 300 is described in greater detail below in connection with an example performed by a processing system. The method 300 begins in step 305 and may proceed to optional step 310 or to step 320.

At optional step 310, the processing system may register at least one vehicle to a vehicle status database, where an entry for the at least one vehicle in the vehicle status database includes information identifying a capability of providing at least one of a plurality of infrastructure services. In one example, the vehicle status database may include entries for an entire fleet of vehicles (e.g., including AVs and non-autonomous vehicles). For instance, an example vehicle status database 127 is illustrated in FIG. 1 and described above.

At step 320, the processing system detects a loss of power event for a managed area, where the managed area includes a plurality of infrastructure elements that rely upon electric power grid power, and where the plurality of infrastructure elements provides a plurality of infrastructure services. In one example, step 320 may comprise identifying affected infrastructure elements and/or infrastructure services of the infrastructure elements that may need to be temporarily replaced or replicated. The plurality of infrastructure services may comprise, for example, a safety lighting service (e.g., street lights, or path lights, which may include lights along walking paths, alleys, parking lots, etc.). In one example, the plurality of infrastructure services may comprise a traffic signal service (e.g., to replace one or more traffic signals/traffic lights at an intersection or other road feature (e.g., a pedestrian light in the middle of a street block, etc.)). In one example, the plurality of infrastructure services may include a communication network connectivity service. In one example, the plurality of infrastructure services may include an electric power provisioning service. For instance, the electric power system/grid may also be considered as an infrastructure element for which a replacement electric power provisioning service may be deployed.

At step 330, the processing system identifies at least one vehicle that is capable of providing at least one of the plurality of infrastructure services, where the at least one vehicle comprises an autonomous vehicle (AV). In one example, the autonomous vehicle (AV) may comprise an autonomous aerial vehicle (AAV). In another example, the AV may comprise an autonomous surface-operating vehicle (e.g., ground and/or water-based, and alternatively or additionally may comprise a submersible vehicle). In one example, the at least one vehicle may comprise a plurality of vehicles, e.g., including two or more AV. In addition, in one example, the plurality of vehicles may further comprise at least one non-autonomous vehicle. In one example, step 330 may include determining at least one of a current location or an anticipated location of the at least one vehicle. In one example, step 330 may further include determining an availability of the at least one vehicle. In one example, the availability may include a duration of time for which the at least one vehicle is capable of providing the at least one of the plurality of infrastructure services. In one example, step 330 may include identifying at least two vehicles capable of performing at least two of the plurality of infrastructure services, where the at least one vehicle is identified to provide the at least one of the plurality of infrastructure services and where at least a second vehicle is identified to provide at least a second of the plurality of infrastructure services.

At step 340, the processing system transmits an instruction to the at least one vehicle to deploy to a location of at least one of the plurality of infrastructure elements to provide the at least one of the plurality of infrastructure services. For instance, the location of the at least one of the plurality of infrastructure elements may comprise a road intersection, an alleyway, a roadway, a walking path, a park, etc. To illustrate, as noted above, the plurality of infrastructure services may comprise a traffic signal service. Thus, for instance, in one example, step 340 may include deploying an AAV to function as a traffic light at an intersection. In another example, a surface-operating AV may be deployed, e.g., where a traffic signal unit may be mounted on top of a roof of the AV to enable the AV to provide a traffic signal service. In one example, the instruction is to deploy to the location for a duration of time that may be determined at step 330.

In one example, step 340 may include transmitting an instruction to the at least the second vehicle to deploy to the location to provide the at least the second of the plurality of infrastructure services (e.g., in an example in which step 330 includes the identification of the at least the second vehicle to deploy to the location to provide the at least the second of the plurality of infrastructure services). For instance, the processing system may deploy multiple AVs to a same intersection to provide different services (e.g., a first AV can provide street lighting nearby, while another can operate as a traffic light). In one example, the instruction to the at least one vehicle may further include an instruction to interact with the at least the second vehicle for at least one task, and the instruction to the at least the second vehicle may further include an instruction to interact with the at least one vehicle for the at least one task. For instance, one of the AVs may be instructed to provide a traffic signal service while another may sense traffic and give information on light timing to the first. As noted above, the plurality of infrastructure services may include an electric power provisioning service. For instance, the at least one task may comprise a recharging task or a refueling task. In another example, two AVs may coordinate to provide an infrastructure service. For example, two or more AVs may coordinate with each other to provide one set of traffic lights for each direction of approach to a four-way intersection (e.g., where the sets of lights are coordinated/time-synchronized with each other at the intersection). It should be noted that in each example, the coordination and/or collaboration may be in accordance with instructions from the processing system to the respective AVs.

At optional step 350, the processing system may identify at least a second vehicle that is capable of providing the at least one of the plurality of infrastructure services (e.g., for a subsequent time period). For instance optional step 350 may be the same or similar to step 330, but may be for a later time and may consider AVs (or non-autonomous vehicles) besides the AV identified at step 330.

At optional step 360, the processing system may transmit an instruction to the at least the second vehicle to deploy to the location to provide the at least one of the plurality of infrastructure services for a time following the duration of time for which the at least one vehicle is capable of providing the at least one of the plurality of infrastructure services. For example, as noted above, two or more AVs may take turns providing a traffic signal service (e.g., allowing time for each other to recharge/refuel while enabling a continuous provisioning of the traffic signal service), and similarly for other infrastructure services.

Following step 340 or optional step 360, the method 300 may proceed to step 395. At step 395, the method 300 ends.

It should be noted that the method 300 may be expanded to include additional steps, or may be modified to replace steps with different steps, to combine steps, to omit steps, to perform steps in a different order, and so forth. For instance, in one example the processing system may repeat one or more steps of the method 300, such as steps 310-340 or steps 310-360 for additional locations in the managed areas, for different managed areas, for the same location and/or managed area for another loss of power event, and so forth. In one example, step 330 may include transmitting one or more offers, including incentives to provide services, obtaining one or more responses, collecting bids from multiple vehicles, and deciding between offers based on trust ratings, competing bids (e.g., costs) for different vehicles, which vehicle is closest, which can provide an infrastructure service for the longest duration of time, or other factors. In one example, optional steps 350 and 360 may be contemporaneous with steps 330 and 340, respectively. In various other examples, the method 300 may further include or may be modified to comprise aspects of any of the above-described examples in connection with FIGS. 1 and 2, or as otherwise described in the present disclosure. Thus, these and other modifications are all contemplated within the scope of the present disclosure.

In addition, although not expressly specified above, one or more steps of the method 300 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 3 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the example embodiments of the present disclosure.

FIG. 4 depicts a high-level block diagram of a computing system 500 (e.g., a computing device or processing system) specifically programmed to perform the functions described herein. For example, any one or more components, devices, and/or systems illustrated in FIG. 1 or described in connection with FIGS. 1-3, may be implemented as the computing system 400. As depicted in FIG. 4, the computing system 400 comprises a hardware processor element 402 (e.g., comprising one or more hardware processors, which may include one or more microprocessor(s), one or more central processing units (CPUs), and/or the like, where the hardware processor element 402 may also represent one example of a “processing system” as referred to herein), a memory 404, (e.g., random access memory (RAM), read only memory (ROM), a disk drive, an optical drive, a magnetic drive, and/or a Universal Serial Bus (USB) drive), a module 405 for deploying an autonomous vehicle to a location of an infrastructure element to provide an infrastructure service in response to a loss of power event, and various input/output devices 406, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one hardware processor element 402 is shown, the computing system 400 may employ a plurality of hardware processor elements. Furthermore, although only one computing device is shown in FIG. 4, if the method(s) as discussed above is implemented in a distributed or parallel manner for a particular illustrative example, e.g., the steps of the above method(s) or the entire method(s) are implemented across multiple or parallel computing devices, then the computing system 400 of FIG. 4 may represent each of those multiple or parallel computing devices. Furthermore, one or more hardware processor elements (e.g., hardware processor element 402) can be utilized in supporting a virtualized or shared computing environment. The virtualized computing environment may support one or more virtual machines which may be configured to operate as computers, servers, or other computing devices. In such virtualized virtual machines, hardware components such as hardware processors and computer-readable storage devices may be virtualized or logically represented. The hardware processor element 402 can also be configured or programmed to cause other devices to perform one or more operations as discussed above. In other words, the hardware processor element 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer-readable instructions pertaining to the method(s) discussed above can be used to configure one or more hardware processor elements to perform the steps, functions and/or operations of the above disclosed method(s). In one example, instructions and data for the present module 405 for deploying an autonomous vehicle to a location of an infrastructure element to provide an infrastructure service in response to a loss of power event (e.g., a software program comprising computer-executable instructions) can be loaded into memory 404 and executed by hardware processor element 402 to implement the steps, functions or operations as discussed above in connection with the example method(s). Furthermore, when a hardware processor element executes instructions to perform operations, this could include the hardware processor element performing the operations directly and/or facilitating, directing, or cooperating with one or more additional hardware devices or components (e.g., a co-processor and the like) to perform the operations.

The processor (e.g., hardware processor element 402) executing the computer-readable instructions relating to the above described method(s) can be perceived as a programmed processor or a specialized processor. As such, the present module 405 for deploying an autonomous vehicle to a location of an infrastructure element to provide an infrastructure service in response to a loss of power event (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium may comprise a physical device, a hardware device, or a device that is discernible by the touch. More specifically, the computer-readable storage device or medium may comprise any physical devices that provide the ability to store information such as instructions and/or data to be accessed by a processor or a computing device such as a computer or an application server.

While various examples have been described above, it should be understood that they have been presented by way of example only, and not limitation. Thus, the breadth and scope of a preferred example should not be limited by any of the above-described examples, but should be defined only in accordance with the following claims and their equivalents.

What is claimed is:

1. A method comprising:
detecting, by a processing system including at least one processor, a loss of power event for a managed area, wherein the managed area includes a plurality of infrastructure elements that rely upon electric power grid power, wherein the plurality of infrastructure elements provides a plurality of infrastructure services;
identifying, by the processing system, at least one vehicle that is capable of providing at least one of the plurality of infrastructure services, wherein the at least one vehicle comprises an autonomous vehicle; and
transmitting, by the processing system, an instruction to the at least one vehicle to deploy to a location of at least one of the plurality of infrastructure elements to provide the at least one of the plurality of infrastructure services.

2. The method of claim 1, wherein the at least one vehicle comprises a plurality of vehicles, wherein the plurality of vehicles further comprises at least one non-autonomous vehicle.

3. The method of claim 1, wherein the plurality of infrastructure services comprises a safety lighting service.

4. The method of claim 1, wherein the plurality of infrastructure services comprises a traffic signal service.

5. The method of claim 1, wherein the plurality of infrastructure services comprises a communication network connectivity service.

6. The method of claim 1, wherein the plurality of infrastructure services comprises an electric power provisioning service.

7. The method of claim 1, wherein the autonomous vehicle comprises an autonomous aerial vehicle.

8. The method of claim 1, wherein the autonomous vehicle comprises an autonomous surface-operating vehicle.

9. The method of claim 1, wherein the identifying comprises:
determining a duration of time for which the at least one vehicle is capable of providing the at least one of the plurality of infrastructure services, wherein the instruction is to deploy to the location for the duration of time.

10. The method of claim 9, further comprising:
identifying at least a second vehicle that is capable of providing the at least one of the plurality of infrastructure services; and
transmitting an instruction to the at least the second vehicle to deploy to the location to provide the at least one of the plurality of infrastructure services for a time following the duration of time for which the at least one vehicle is capable of providing the at least one of the plurality of infrastructure services.

11. The method of claim 1, further comprising:
registering the at least one vehicle to a vehicle status database, wherein an entry for the at least one vehicle in the vehicle status database includes information identifying the capability of providing the at least one of the plurality of infrastructure services, wherein the identifying is in accordance with the vehicle status database.

12. The method of claim 11, wherein the identifying comprises:
determining at least one of: a current location or an anticipated location of the at least one vehicle; and
determining an availability of the at least one vehicle.

13. The method of claim 1, wherein the identifying comprises identifying at least two vehicles capable of performing at least two of the plurality of infrastructure services, wherein the at least one vehicle of the at least two vehicles is identified to provide the at least one of the plurality of infrastructure services and wherein at least a second vehicle of the at least two vehicles is identified to provide at least a second of the plurality of infrastructure services.

14. The method of claim 13, wherein the transmitting further comprises transmitting an instruction to the at least the second vehicle to deploy to the location to provide the at least the second of the plurality of infrastructure services.

15. The method of claim 14, wherein the instruction to the at least one vehicle further includes an instruction to interact with the at least the second vehicle for at least one task, and wherein the instruction to the at least the second vehicle further includes an instruction to interact with the at least one vehicle for the at least one task.

16. The method of claim 15, wherein the at least one task comprises:
a recharging task; or
a refueling task.

17. The method of claim 1, wherein the location of the at least one of the plurality of infrastructure elements comprises a road intersection.

18. The method of claim 1, wherein the location of the at least one of the plurality of infrastructure elements comprises at least one of:
an alleyway;
a roadway;
a walking path; or
a park.

19. A non-transitory computer-readable medium storing instructions which, when executed by a processing system including at least one processor, cause the processing system to perform operations, the operations comprising:
detecting a loss of power event for a managed area, wherein the managed area includes a plurality of infrastructure elements that rely upon electric power grid power, wherein the plurality of infrastructure elements provides a plurality of infrastructure services;
identifying at least one vehicle that is capable of providing at least one of the plurality of infrastructure services, wherein the at least one vehicle comprises an autonomous vehicle; and
transmitting an instruction to the at least one vehicle to deploy to a location of at least one of the plurality of infrastructure elements to provide the at least one of the plurality of infrastructure services.

20. An apparatus comprising:
a processing system including at least one processor; and
a computer-readable medium storing instructions which, when executed by the processing system, cause the processing system to perform operations, the operations comprising:
detecting a loss of power event for a managed area, wherein the managed area includes a plurality of infrastructure elements that rely upon electric power grid power, wherein the plurality of infrastructure elements provides a plurality of infrastructure services;
identifying at least one vehicle that is capable of providing at least one of the plurality of infrastructure services, wherein the at least one vehicle comprises an autonomous vehicle; and
transmitting an instruction to the at least one vehicle to deploy to a location of at least one of the plurality of infrastructure elements to provide the at least one of the plurality of infrastructure services.
